(19) United States
(12) Patent Application Publication
(10) Pub. No.: US 2018/0278459 A1
(43) Pub. Date: Sep. 27, 2018

(54) Sharding Of Network Resources In A Network Policy Platform

(71) Applicant: CISCO TECHNOLOGY, INC., San Jose, CA (US)

(72) Inventors: Rohit Prasad, Sunnyvale, CA (US); Hai Vu, San Jose, CA (US); Shih-Chun Chang, San Jose, CA (US); Hoang Nguyen, San Jose, CA (US); Shashi Gandham, Fremont, CA (US); Navindra Yadav, Cupertino, CA (US); Praneeth Vallem, San Jose, CA (US); Sunil Gupta, Milpitas, CA (US); Ravi Prasad, Fremont, CA (US); Paul Lesiak, West Orange, NJ (US)

(21) Appl. No.: 15/470,340

(22) Filed: Mar. 27, 2017

(51) Int. Cl. H04L 29/08; G06F 11/16; H04L 12/24; G06F 11/14; H04L 29/14

(52) U.S. Cl. CPC H04L 29/08279; G06F 11/1625; H04L 41/046; H04L 29/06; G06F 11/1443; H04L 69/40; H04L 67/1034

(57) ABSTRACT

The disclosed technology relates to assigning network agents to communication modules. A network policy system is configured to assign network agents to buckets based on an agent identifier of each agent. The network policy system can assign buckets to communication modules. When a failed communication module is detected, the network policy system can reassigning buckets assigned to the failed communication module to operational communication modules.

### TECHNICAL FIELD

The subject matter of this disclosure relates in general to the field of computer networks, and more specifically for management of entities and resources within a computer network.

### BACKGROUND

A managed network, such as an enterprise private network (EPN), may contain a large number of entities distributed across the network. These entities include, for example, nodes, endpoints, machines, virtual machines, containers (an instance of container-based virtualization), and applications. In addition to being different types, these entities may be grouped in different departments, located in different geographical locations, and/or serve different functions.

An expansive or thorough understanding of the network can be critical for network management tasks such as anomaly detection (e.g., network attacks and misconfiguration), network security (e.g., preventing network breaches and reducing network vulnerabilities), asset management (e.g., monitoring, capacity planning, consolidation, migration, and continuity planning), and compliance (e.g. conformance with governmental regulations, industry standards, and corporate policies). Traditional approaches for managing large networks require comprehensive knowledge on the part of highly specialized human operators because of the complexities of the interrelationships among the entities.

### BRIEF DESCRIPTION OF THE FIGURES

In order to describe the manner in which the above-recited and other advantages and features of the disclosure can be obtained, a more particular description of the principles briefly described above will be rendered by reference to specific embodiments that are illustrated in the appended drawings. Understanding that these drawings depict only embodiments of the disclosure and are not therefore to be considered to be limiting of its scope, the principles herein are described and explained with additional specificity and detail through the use of the accompanying drawings in which:

FIG. 1 is a conceptual block diagram illustrating an example of an intent driven network policy platform, in accordance with various embodiments of the subject technology;

FIG. 2 is an illustration showing contents of an inventory store, in accordance with various embodiments of the subject technology;

FIG. 3 illustrates two examples of inventory filters, in accordance with various embodiments of the subject technology;

FIG. 4 illustrates an example flow filter incorporating two inventory filters, in accordance with various embodiments of the subject technology;

FIG. 5 is a conceptual block diagram illustrating an example of a network entity that includes a network agent, in accordance with various embodiments of the subject technology;

FIG. 6 is a conceptual block diagram illustrating a network environment, in accordance with various embodiments of the subject technology;

FIG. 7 is a conceptual bock diagram illustrating an assignment of buckets to communication modules, in accordance with various embodiments of the subject technology;

FIG. 8 is a conceptual bock diagram illustrating a failure of a communication module, in accordance with various embodiments of the subject technology;

FIG. 9 shows an example process for reassigning network agents to communication modules, in accordance with various embodiments of the subject technology; and

FIGS. 10A and 10B illustrate examples of systems in accordance with some embodiments.

### DESCRIPTION OF EXAMPLE EMBODIMENTS

The detailed description set forth below is intended as a description of various configurations of embodiments and is not intended to represent the only configurations in which the subject matter of this disclosure can be practiced. The appended drawings are incorporated herein and constitute a part of the detailed description. The detailed description includes specific details for the purpose of providing a more thorough understanding of the subject matter of this disclosure. However, it will be clear and apparent that the subject matter of this disclosure is not limited to the specific details set forth herein and may be practiced without these details. In some instances, structures and components are shown in block diagram form in order to avoid obscuring the concepts of the subject matter of this disclosure.

### Overview

Large networks often require comprehensive knowledge on the part of highly specialized human operators (e.g., network administrators) to effectively manage. However, controls available to the human operators are not very flexible and the human operators with the specialized knowledge able to manage the network(s) are often not the individuals with a higher level understanding of how the network should operate with respect to certain applications or functionalities. Furthermore, once a change in network management is executed, it is often difficult to roll back the changes, make alterations, or understand the changes, even for network operators.

The disclosed technology addresses the need in the art for a more intuitive way to manage a network and a way to manage the network in a more targeted manner. For example, many networks may be secured using access control lists (ACLs) implemented by routers and switches to permit and restrict data flow within the network. When an ACL is configured on an interface, the network device examines data packets passing through the interface to determine whether to forward or drop the packet based on the criteria specified within the ACLs. Each ACL includes entries where each entry includes a destination target internet protocol (IP) address, a source target IP address, and a statement of permission or denial for that entry.

The ACLs, however, may be difficult for application developers and other users with limited knowledge of network engineering to understand and use. A development team that builds a particular application, set of applications, or function(s) (e.g., an “application owner”) is typically not responsible for managing an enterprise network and are not expected to have a deep understanding of the network. The application owner understands at a high level how certain applications or functions should operate, which entities should be allowed or restricted from communicating with other entities, and how entities should be allowed or restricted from communicating with other entities (e.g., which ports and/or communication protocols are allowed or restricted). In order to implement desired network policies, the application owner must contact a network operator and communicate their objectives to the network operator. The network operator tries to understand the objectives and then creates ACL entries that satisfy the application owner's objectives.

Even relatively simple network policies take hundreds, thousands, or more ACL entries to implement and ACLs often end up containing millions of entries. For example, to implement a simple network rule where a first subnet of machines cannot communicate with a second subnet of machines requires 2(m×n) ACL entries for a number of m endpoints in the first subnet and a number of n endpoints in the second subnet to explicitly list out each IP address in the first subnet that cannot send data to each IP address in the second subnet and each IP address in the second subnet cannot send data to each IP address in the first subnet. The size of the ACLs can further complicate matters making intelligently altering the ACLs increasingly difficult. For example, if an application owner wants to alter the implemented network policies, it is difficult for the application owner or the network operator to know which ACL entries were created based on the original network policy and, as a result, difficult to identify ACL entries to add, delete, or modify based on the alteration of the network policies.

Furthermore, traditional ACLs permit and restrict data flow within the network at the machine level. For example, ACL entries permit or restrict communication based on a destination target internet protocol (IP) address and a source target IP address. However, in some cases, applications on one network entity (e.g., a physical server, virtual machine, container, etc.) should be able to communicate with other applications on a different network entity, but other communications between the entities should be restricted for security reasons (e.g., some hackers may take advantage of broad traditional ACL entries and use applications to gain access to other areas of the network). Traditional ACL entries are unable to accommodate for more tailored control of network traffic.

Various embodiments of the subject technology address these and other technical problems by providing an intent driven network policy platform that allows both application owner and network operators to define network policies in a more understandable manner and provides these users with finer levels of controls.

### DETAILED DESCRIPTION

Various embodiments of the disclosure are discussed in detail below. While specific implementations are discussed, it should be understood that this is done for illustrative purposes only. A person skilled in the relevant art will recognize that other components and configurations may be used without departing from the spirit and scope of the disclosure.

Various embodiments relate to an intent driven network policy platform configured to ingest network data and generate an inventory of network entities. The network policy platform receives a user intent statement, translates the intent into network policies, and enforces the network policies.

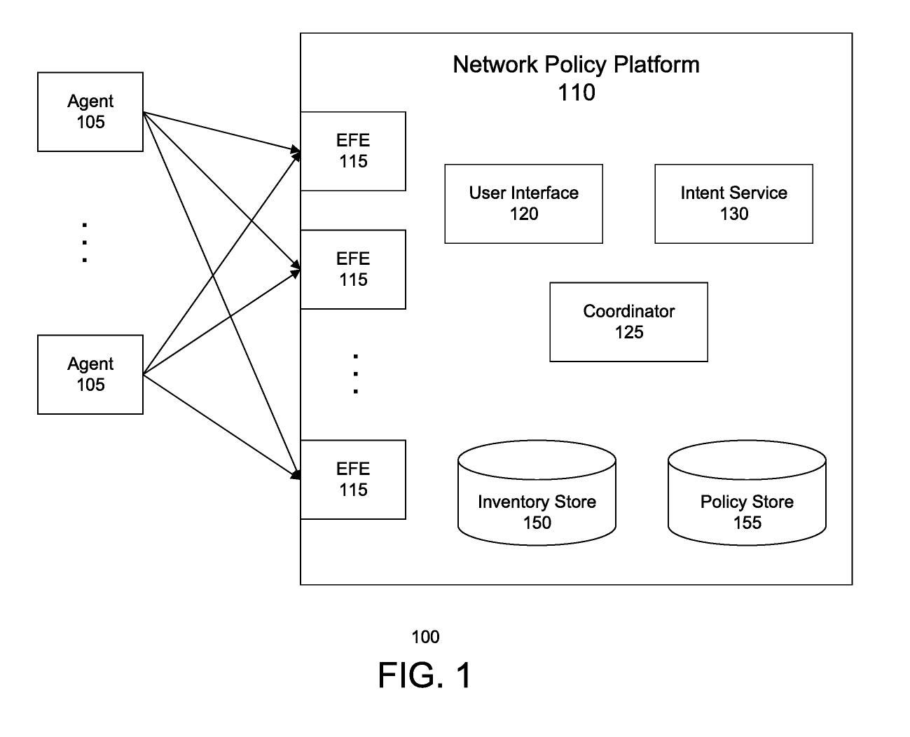

FIG. 1 is a conceptual block diagram illustrating an example network environment 100 that includes an intent driven network policy platform 110, in accordance with various embodiments of the subject technology. Various embodiments are discussed with respect to an enterprise private network (EPN) for illustrative purposes. However, these embodiments and others may be applied to other types of networks. For example, the network environment 100 may be implemented by any type of network and may include, for example, any one or more of a cellular network, a satellite network, a personal area network (PAN), a local area network (LAN), a wide area network (WAN), a broadband network (BBN), the Internet, and the like. The network environment 100 can be a public network, a private network, or a combination thereof. The network environment 100 may be implemented using any number of communications links associated with one or more service providers, including one or more wired communication links, one or more wireless communication links, or any combination thereof. Additionally, the network environment 100 can be configured to support the transmission of data formatted using any number of protocols.

The network environment 100 includes one or more network agents 105 configured to communicate with an intent driven network policy platform 110 via enforcement front end modules (EFEs) 115. The intent driven network policy platform 110 is shown with one or more EFEs 115, a user interface module 120, a coordinator module 125, an intent service module 130, an inventory store 150, and a policy store 155. In other embodiments, the intent driven network policy platform 110 may include additional components, fewer components, or alternative components. The network policy platform 110 may be implemented as a single machine or distributed across a number of machines in the network.

Each network agent 105 may be installed on a network entity and configured to receive network policies (e.g., enforcement policies, configuration policies, etc.) from the network policy platform 110 via the enforcement front end modules 115. After an initial installation on a network entity (e.g., a machine, virtual machine, or container, etc.), a network agent 105 can register with the network policy platform 110 and communicate with one or more EFEs to receive network policies that are configured to be applied to the host on which the network agent 105 is running. In some embodiments, the network policies may be received in a high-level, platform independent format. The network agent 105 may convert the high-level network policies into platform specific policies and apply any number of optimizations before applying the network policies to the host network entity. In some embodiments, the high-level network policies may be converted at the network policy platform 110.

Each network agent 105 may further be configured to observe and collect data and report the collected data to the intent driven network policy platform 110 via the EFEs 115. The network agent 105 may collect policy enforcement related data associated with the host entity such as a number of policies being enforced, a number of rules being enforced, a number of data packets being allowed, dropped, forwarded, redirected, or copied, or any other data related to the enforcement of network policies. The network agent 105 may also collect data related to host entity performance such as CPU usage, memory usage, a number of TCP connections, a number of failed connection, etc. The network agent 105 may also collect other data related to the host such as an entity name, operating system, entity interface information, file system information, applications or processes installed or running, or disks that are mounted.

The enforcement front end modules (EFEs) 115 are configured to handle the registration of the network agents 105 with the network policy platform 110, receive collected data from the network agents 105, and store the collected data in inventory store 150. The EFEs may be further configured to store network policies (high-level platform independent policies or platform specific policies) in memory, periodically scan a policy store 155 for updates to network policies, and notify and update network agents 105 with respect to changes in the network policies.

The user interface 120 receives input from users of the network policy platform 110. For example, the user interface 120 may be configured to receive user configured data for entities in the network from a network operator. The user configured data may include IP addresses, host names, geographic locations, departments, functions, a VPN routing/forwarding (VRF) table, or other data for entities in the network. The user interface 120 may be configured to collect the user configured data and store the data in the inventory store 150.

The user interface 120 may also be configured to receive one or more user intent statements. The user intent statements may be received from a network operator, application owner, or other administrator or through another entity via an application programming interface (API). A user intent statement is a high-level expression of one or more network rules that may be translated into a network policy.

The user interface 120 may pass a received user intent statement to the intent service 130 where the intent service 130 is configured to format the user intent statements and transform the user intent statement into network policies that may be applied to entities in the network. According to some embodiments, the intent service 130 may be configured to store the user intent statements, either in formatted or non-formatted form, in an intent store. After the user intent statements are translated into network policies, the intent service 130 may store the network policies in policy store 155. The policy store 155 is configured to store network policies. The network policies may be high-level platform independent network policies or platform specific policies. In some embodiments, the policy store 155 is implemented as a NoSQL database.

The intent service 130 may also track changes to intent statements and make sure the network policies in the policy store are up-to-date with the intent statements in the intent store. For example, if a user intent statement in the intent store is deleted or changed, the intent service 130 may be configured to located network policies associated with the deleted user intent statement and delete or update the network policies as appropriate.

The coordinator module 125 is configured to assign network agents 105 to EFEs. For example, the coordinator 125 may use a sharding technique to balance load and improve efficiency of the network policy platform 110. The coordinator 125 may also be configured to determine if an update to the policy store is needed and update the policy store accordingly. The coordinator 125 may further be configured to receive data periodically from the network agents 105 via the EFEs 115, store the data in the inventory store 150, and update the inventory store 150 if necessary.

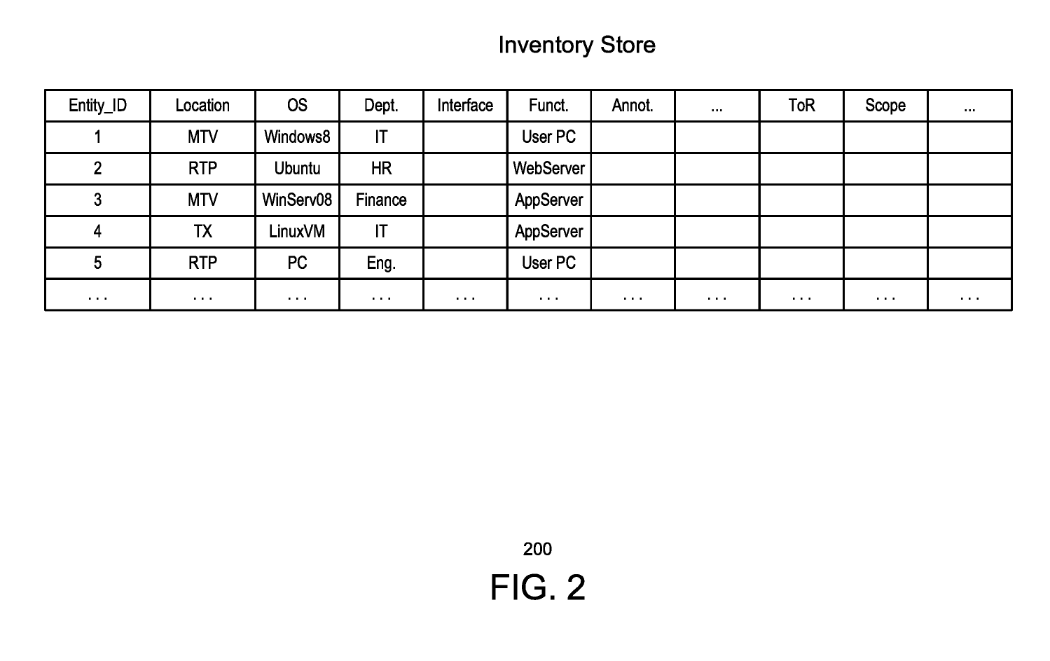

FIG. 2 is an illustration showing contents of an inventory store 200, in accordance with various embodiments of the subject technology. The inventory store 200 is configured to contain data and attributes for each network entity managed by the intent driven network policy platform 110. The network entities may include machines (e.g., servers, personal computers, laptops), virtual machines, containers, mobile devices (e.g., tablets or smart phones), smart devices (e.g., set top boxes, smart appliances, smart televisions, internet-of-things devices), or network equipment, among other computing devices. Although the inventory store 200 is implemented as a conventional relational database in this example, other embodiments may utilize other types of databases (e.g., NoSQL, NewSQL, etc.).

The inventory store 200 may receive user configured data from the user interface 120 and data received from the network agents 105 via the EFEs 115 and store the data in records or entries associated with network entities managed by the network policy platform 110. Each record in the inventory store 200 may include attribute data for a network entity such as one or more entity identifiers (e.g., a host name, IP address, MAC addresses, hash value, etc.), a geographic location, an operating system, a department, interface data, functionality, a list of one or more annotations, file system information, disk mount information, top-of-rack (ToR) location, and a scope.

In some embodiments, the inventory store 200 may also include entity performance and network enforcement data either together with the attribute data or separately in one or more separate data stores. The performance and network enforcement data may include CPU usage, memory usage, a number of TCP connections, a number of failed connections, a number of network policies, or a number of data packets that have been allowed, dropped, forwarded, or redirected. The inventory store 200 may include historical performance or enforcement data associated with network entities or metrics calculated based on historical data.

A user intent statement is a high-level expression of that may be translated into one or more network policies. A user intent statement may be composed of one or more filters and at least one action. The filters may include inventory filters that identify network entities on which the action is to be applied and flow filters that identify network data flows on which the action is to be applied.

For example, if a user wished to identify all network entities located in Mountain View, Calif. (abbreviated MTV in the location column of the inventory store), the inventory filter “Location==MTV” may be used. If a user wished to identify all network entities located in a Research Triangle Park facility in North Carolina (abbreviated RTP in the location column of the inventory store), the inventory filter “Location==RTP” may be used. Inventory filters may also identify relationships between two or more sets of entities (e.g., a union or intersection of sets). For example, if a user wished to identify all network entities located in Mountain View, Calif. and running Windows 8 operating system, the inventory filter “Location==MTV and OS==Windows8” may be used.

A flow filter identifies network data flows. For example, if a user wished to identify all data flows from network entities in Mountain View to network entities in the Research Triangle Park facility, the following flow filter may be used:

Source:Location==MTV

Destination:Location==RTP

Each filter may further be defined beforehand and assigned a name for more convenient use. For example, the inventory filter “Location==MTV” may be assigned the name “MTV_entities” and the inventory filter “Location==RTP” may be assigned the name “RTP_entities.” As a result, a user may use the following to achieve the same result as the above example flow filter:

Source:MTV_entities

Destination:RTP_entities

Different actions may be applied to different filters. For example, actions applicable to inventory filters may include annotation and configuration actions. Annotating actions adds tags or labels to network items in the inventory store or flow data. Annotations may help network operators identify network entities. Configuration actions may be used to configure network entities. For example, some configuration actions may be used to set a CPU quota for certain applications, processes, or virtual machines. Other configuration actions may enable or disable monitoring of certain metrics, collection and transmittal of certain data, or enforcement of certain network policies. Some configuration actions may also be able to enable or disable certain modes within a network entity. For example, some entities may be configured to run in a “high visibility mode” in which most metrics and data (e.g., full time series data) are collected and transmitted to the network policy platform for analysis or in “low visibility mode” in which only a small subset of the available metrics and data are collected and transmitted. Some configuration actions are able to enable or disable these modes.

Actions applicable to flow filters may include annotation or network enforcement actions. Network enforcement actions include, for example, allowing data packets, dropping data packets, copying data packets, redirecting data packets, encrypting data packets, or load balance across network entities.

Using the above examples, a user that wishes to drop all data flowing from entities in Mountain View to entities in Research Triangle Park may use the following user intent statement:

Source:MTV_entities

Destination:RTP_entities

Action:Drop

User intent statements may further specify types of communications or communication protocols used, ports used, or use any other filter to identify a network entity or network flow on which to apply an action. For example, if the user only wishes to drop transmission control protocol (TCP) communications out of port 80 for these network entities, the following user intent statement may be used instead:

Source:MTV_entities

Destination:RTP_entities

Action:Drop

Protocol:TCP

Port:80

In another example, to disable all incoming connections to network entities running a Windows 8 operating system, a user can utilize the following user intent statement:

Source:*

Destination:Win8_Filter

Action:Drop

In the above user intent statement, “Win_Filter” is the name of an inventory filter that includes “OS==Windows8.”

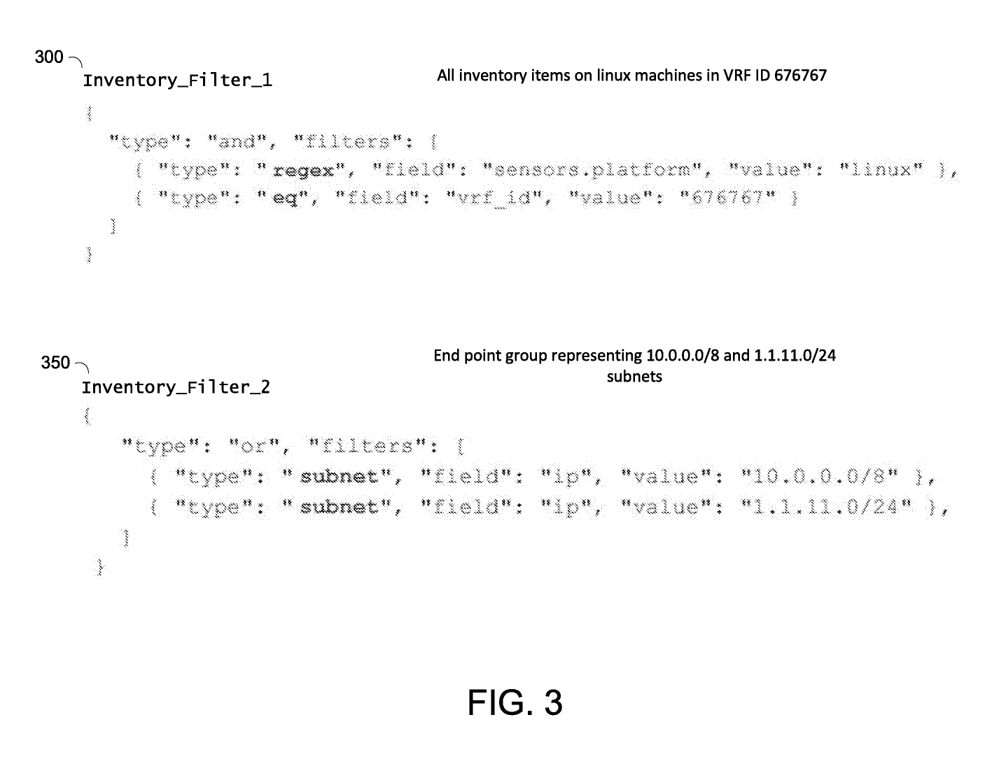

The example user intent statements above are presented for illustrative purposes. In some embodiments, user intent statements, inventory filters, flow filters, or actions may appear in different formats or even in a natural language format. For example, FIG. 3 illustrates two example inventory filters, in accordance with various embodiments of the subject technology. The first inventory filter 300 is named “Inventory_Filter_1” and is configured to identify all network entities in the inventory store that run on a Linux operating system and have a VRF ID of 676767. The second inventory filter 350 is named “Inventory_Filter_2” and is configured to identify all network entities in the inventory store that represent the 10.0.0.0/8 and 1.1.11.0/24 subnets.

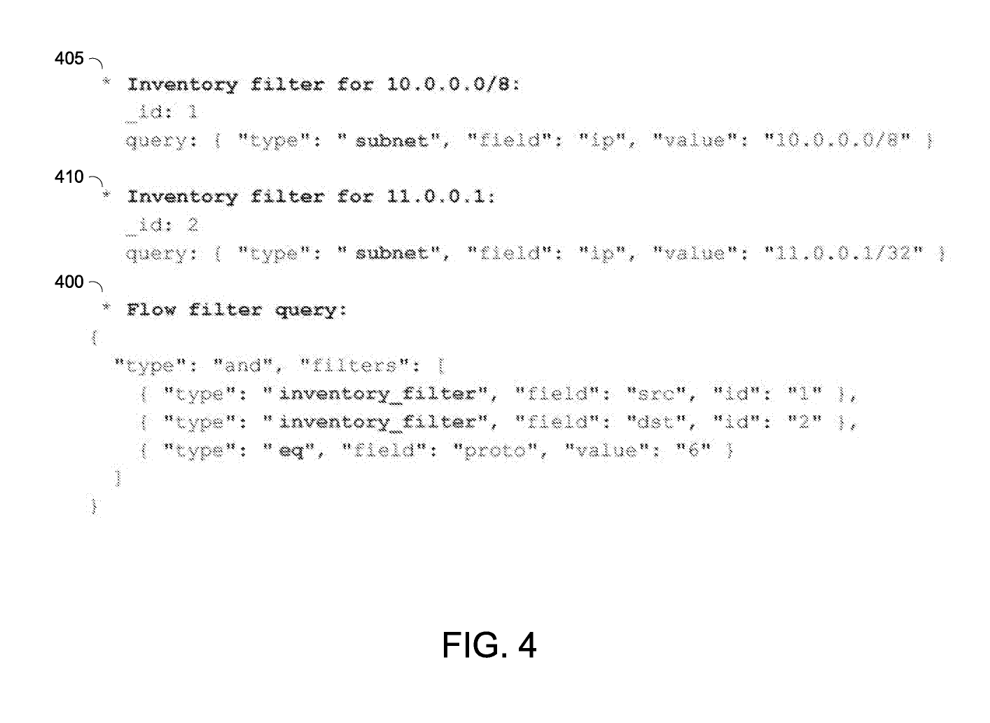

FIG. 4 illustrates an example flow filter incorporating two inventory filters, in accordance with various embodiments of the subject technology. The flow filter 400 is configured to identify TCP data flows between the 10.0.0.0/8 and 11.0.0.1 subnets. The flow filter 400 further uses two inventory filters 405 and 410 to help identify the subnets.

According to various embodiments, an example process for managing a network using inventory filters can be performed by a network policy system (e.g., the network policy platform 110 of FIG. 1) or similar system. The system may generate an inventory store that includes records for network entities in the network. The records may be created or updated based on configuration data received from a network operator. The configuration data may include various attributes of certain network entities. The attributes may include, for example, an internet protocol (IP) address, a host name, a geographic location, or a department. The configuration data may also include annotations, labels, VPN routing/forwarding (VRF) information, interface information, or any other data that may be used to identify one or more network entities.

The records may further be created, updated, or supplemented with information observed by network agents and reported to the network policy system by the network agents. This information may include operating system information, hostnames, interface information, entity identifiers, policy enforcement information, or data related to entity performance. Policy enforcement information may include a number of policies being enforced, a number of rules being enforced, a number of data packets being allowed, dropped, forwarded, redirected, or copied, or any other data related to the enforcement of network policies. Data related to entity performance may include CPU usage, memory usage, a number of TCP connections, a number of failed connection, applications or processes installed or running, disks that are mounted, or other time series data.

The system may receive a user intent statement that includes at least one filter and an action. The user intent statement may be received from a network operator, application owner, or other administrator via a user interface or through another party or service via an application program interface (API). The filter may be an inventory filter configured to help identify network entities on which the action is to be applied or a flow filter configured to help identify network data flows on which the action is to be applied. The action may be an enforcement action, a configuration action, or an annotation action.

The system may query the inventory store to identify network entities to which the user intent statement applies. For example, system may query the inventory store using the one or more filters found in the user intent statement to identify network entities that match the conditions of the filters. The filters may include one or more attributes that can be used to narrow down the network entities to only those to which the action is to be applied. The attributes may be, for example, an entity type (e.g., machine, virtual machine, container, process, etc.), an IP subnet, an operating system, or any other information that may be found in the inventory store and used to identify network entities.

The system generates network policies that apply the action to the network entities identified by the query. According to some embodiments, the network policies for user intent statements that include a flow filter or an enforcement action may be implemented in the form of one or more access control lists (ACLs). In some embodiments, network policies for user intent statements that include an annotation action or configuration action may be implemented in the form of instructions to the network entity or a network agent to implement the actions.

The system then enforces the network policies. According to some embodiments, some network policies may be enforced on the system. However, in some embodiments, the system transmits the network policies to one or more network agents configured to implement the network policies on the network entities.

According to various embodiments of the disclosure, a user or service is able to provide a user intent statement that the system uses to generate multiple network policies. Accordingly, the user need not spend time and resources explicitly crafting each network policy. Instead, the user may specify a reduced number of user intent statements that express the user's network management desires. Furthermore, the user intent statements are more understandable to network operators and application owners and the system is configured to take the user intent statements and translate the statements into network policies that network agents or network entities may use to implement the user's network management desires.

In some embodiments, the user intent statements are translated into platform independent network policies and stored in the policy store. To enforce these network policies, the network policy system transmits the platform independent network policies to network agents running on network entities, where the platform independent network policies are converted into platform specific network policies and implemented.

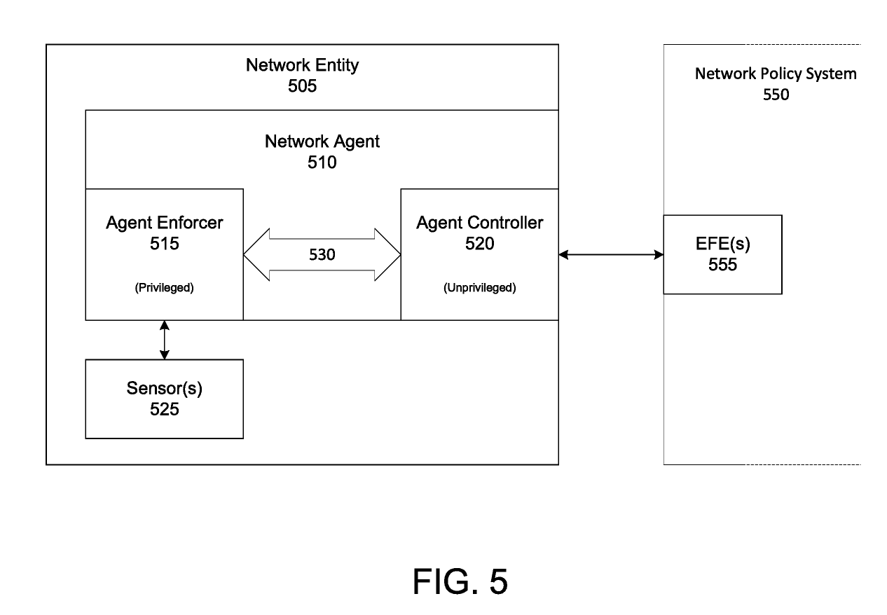

FIG. 5 is a conceptual block diagram illustrating an example of a network entity 505 that includes a network agent 510, in accordance with various embodiments of the subject technology. The network entity 505 may be a physical machine (e.g., a server, desktop computer, laptop, tablet, mobile device, set top box, or other physical computing machine), a virtual machine, a container, an application, or other computing unit. A network agent 510 may be installed on the network entity 505 and may be configured to receive network policies (e.g., enforcement policies, configuration policies, etc.) from the network policy system 550 via one or more enforcement front end (EFE) modules 555.

After an initial installation on a network entity 505, a network agent 510 can register with the network policy system 550. According to some embodiments, the network agent 510 may read the Basic Input/Output System (BIOS) universally unique identifier (UUID) of the network entity 505, gather other host specific information, and access an agent identifier for the network agent 510. The network agent 510 generates a registration request message containing the agent identifier, host specific information (including the BIOS UUID) and transmits the registration request message to an EFE module 555. In some cases (e.g., when a network agent is just installed), the network agent 510 may not have an agent identifier. Accordingly, this field in the registration request message may be kept blank until one is assigned.

The EFE module receives the registration request message and, if the request message contains an agent identifier, the EFE module will validate that the BIOS UUID is the same as the BIOS UUID for the entry associated with the agent identifier in the inventory store. If the information matches, the agent identifier in registration request is validated and the network agent 510 is registered. The EFE module may generate a registration response message with the validated agent identifier and transmit the registration response message to the network agent. A BIOS UUID that does not match may indicate that the network agent's identity has changed. Accordingly, the EFE module may generate a new agent identifier, create an entry in the inventory store for the new agent identifier and transmit the new agent identifier to the network agent in the registration response message. If the network agent receives a registration response message that includes an agent identifier which is different from the agent identifier the network agent sent in the registration request message, the network agent will update its agent identifier and adopt the received agent identifier.

An EFE module 555 may send network policy configuration messages as a separate message or part of the registration response message. The network policy configuration messages may contain platform independent network policies to implement on the network entity 505 as well as version information. The network agent 510 receives a network policy configuration message and checks the currently applied policy version. If the policy version for the received network policy configuration message is lower than or equal to the applied version, the network agent 510 does not need to update the applied policies. If, on the other hand, the policy version is higher than the applied version, the network agent 510 will process the received network policy configuration message. In some embodiments, the network policies in the network policy configuration message may be in a platform independent format. The network agent 510 may convert the platform independent network policies into platform specific policies and apply any number of optimizations before applying the network policies to the network entity 505.

The network agent 510 may further be configured to observe and collect data and report the collected data to the network policy system 550 via the EFE modules 555. The network agent 510 may collect policy enforcement related data associated with the host entity such as a number of policies being enforced, a number of rules being enforced, a number of data packets being allowed, dropped, forwarded, redirected, or copied, or any other data related to the enforcement of network policies. The network agent 510 may also collect data related to host entity 505 performance such as CPU usage, memory usage, a number of TCP connections, a number of failed connection, etc.

According to some embodiments, some of the information collected by the network agent 510 may be obtained by one or more sensors 525 of the network entity 505. The sensors 525 may be physical sensors or logical sensors and, in some embodiments, may be a part of the network agent 510 (e.g., a part of the agent enforcer 515 shown in FIG. 5). The network agent 510 may also collect other data related to the host such as an entity name, operating system, entity interface information, file system information, applications or processes installed or running, or disks that are mounted. The network agent 510 may collect the information, store the information, and send the information to an EFE module 555 from time to time.

According to some embodiments, the network agent 510 may be partitioned into two or more portions with varying permissions or privileges in order to provide additional protections to the network entity 505. For example, in FIG. 5, the network agent 510 is shown to include an agent enforcer 515 and an agent controller 520.

The agent controller 520 is associated with an unprivileged status that does not grant the agent controller 520 certain privileges and may be unable to directly access system protected resources. The agent controller 520 is configured to communicate with the EFE modules 555 of the network policy system 550 via a Secure Sockets Layer (SSL) channel and pass critical data to the agent enforcer via an interprocess communication (IPC) channel 530. Interprocess communications (IPC) are communication channels provided by an operating system running on the network entity 505 that enable processes running on the network entity 505 to communicate and share data.

For example, the agent controller 520 may receive platform independent network policies from one or more EFE modules 555 and pass the network policies to the agent enforcer 515 via the IPC channel 530. The agent controller 520 may also receive data collected by the agent enforcer 515 (e.g., policy enforcement related data, data related to entity performance, or other data related to the network entity 505) via the IPC channel 530, generate a message containing the collected data, and transmit the message to one or more EFE modules 555.

The agent enforcer 515 is associated with a privileged status that provides the agent enforcer 515 with additional privileges with respect to the network entity 505. For example, the agent enforcer may directly access or manipulate the network entity's protected resources such as a system firewall, CPU usage, memory usage, sensors 525, or system interfaces. The agent enforcer 515 may be configured to manage registration of the network agent 510 and select which EFE modules 555 with which to communicate. The agent enforcer 515 may further validate network policies received from the network policy system 550 to ensure that the network policies do not violate any sanity checks or golden rules (e.g., a network policy that blocks communication from a port that communicates with EFE modules 555 may be ignored) and translate platform independent network policies received from the network policy system 550 to platform specific policies. The agent enforcer 515 may also maintain a policy cache, enforce platform specific network policies, and determine whether a network policy has been altered. The agent enforcer 515 may also monitors system metrics and policy enforcement metrics so that the data may periodically be sent to the network policy system 550 for analysis.

According to some embodiments, the agent enforcer 515 and the agent controller 520 may run independently and the separation of the agent enforcer 515 and the agent controller 520 allow for a more secure network agent 510 and network entity 505. For example, the agent enforcer 520 may have no external socket connections in order to reduce the number of vulnerable areas that malicious actors (e.g., hackers) may attack. Although the agent controller 520 communicates with the network policy system 550 via a SSL channel, damage caused by the corruption of the agent controller 520 is limited since the agent controller 520 is unable to directly access privileged resources and cannot enforce arbitrary network policies.

As the scale of the network increases, the number of network entities and network entities running on them increase, or the number of network policies enforced increases, burdens on a network policy system supporting the network also increases. For example, there may be thousands or even millions of agents, billions of policies, and terabytes of policy data. According to some embodiments, additional communication modules (e.g., EFE modules) may be used to address the increased burdens. However, it may be expensive to equip each communication module with enough resources to handle requests from all network agents. Accordingly, in some embodiments, a load balancing scheme may be used where responsibilities may be sharded or partitioned across smaller, more manageable distributed network resources.

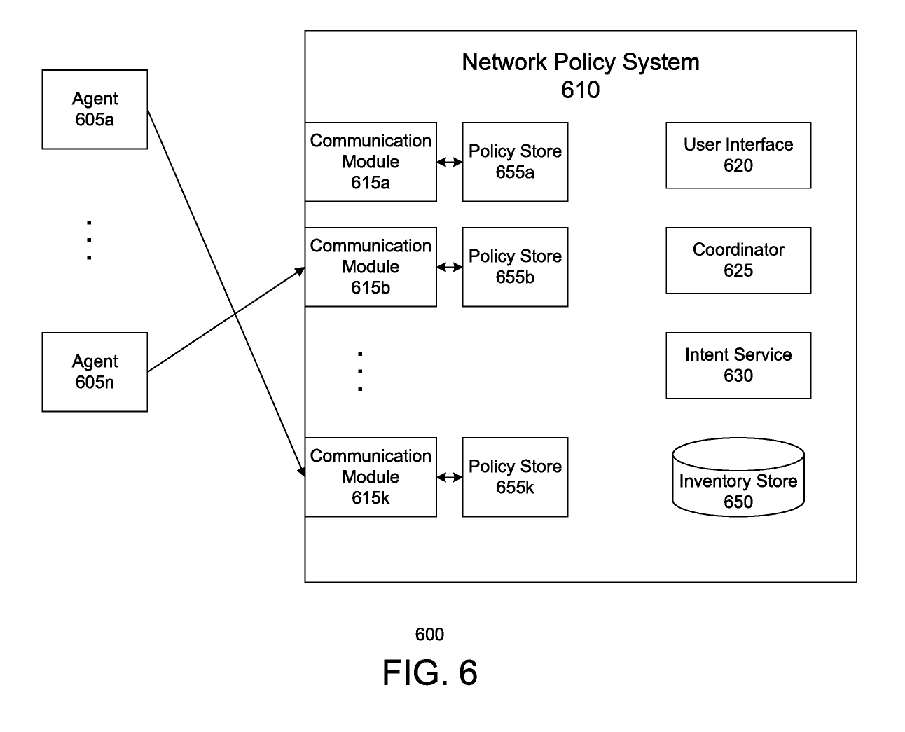

FIG. 6 is a conceptual block diagram illustrating a network environment, in accordance with various embodiments of the subject technology. In other embodiments, the network policy system 610 may include additional components, fewer components, or alternative components. The network policy system 610 may be implemented as a single machine or distributed across a number of machines in the network. The network environment 600 includes one or more network agents 605a-605n configured to communicate with a network policy system 610 via communication modules 615a-615k (e.g., EFE modules). The network policy system 610 is shown with one or more communication modules 615a-615k, a user interface module 620, a coordinator module 625, an intent service module 630, an inventory store 650, and a number of policy store instances 655a-655k.

Each of the network agents 605a-605n may be installed on a network entity and configured to receive network policies (e.g., enforcement policies, configuration policies, etc.) from the network policy system 610 via one of the communication modules 615a-615k. According to some embodiments, each of the various network agents 605a-605n may be assigned to a communication module in order to balance the load on the communication modules 615a-615k. Furthermore, each of the communication modules 615a-615k may be associated with an instance of a policy store 655a-655k configured to store network policies for the network agents assigned to the corresponding communication module. In some embodiments, the policy store instance may also be a backup for another set of agents assigned to another communication module in case that communication module fails. The policy store instance may store network policies for agents assigned to that communication module as well.

Each of the network agents 605a-605n may further be configured to observe and collect data and report the collected data to the network policy platform 610 via the communication module it is assigned to. The network agent may collect policy enforcement related data associated with the host entity, data related to host entity performance, or other data related to the host.

The communication modules 615a-615k are configured to handle the registration of the network agents 605a-605n with the network policy platform 610, receive collected data from the network agents 605a-605n, and store the collected data in inventory store 650. Network policies for agents assigned to a particular communication module may be stored in a policy store instance assigned to the communication module. In some embodiments, the policy store instance may be a part of the communication module or in communication with the communication module.

The user interface 620 receives input from users of the network policy platform 110. For example, the user interface 620 may be configured to receive user configured data for entities in the network from a network operator and store the data in the inventory store 650. The user interface 620 may also be configured to receive one or more user intent statements. The user interface 620 may pass a received user intent statement to the intent service 630 where the intent service 630 is configured to format the user intent statements and transform the user intent statement into network policies that may be applied to entities in the network. After the user intent statements are translated into network policies, the intent service 630 may sort the network policies based on the network agents that they apply to and store the network policies in policy store instances that are associated with communication modules that the agents are assigned to. For example, if network agent 605a is assigned to communication module 615l, then the network policies that will be applied to network agent 605a are stored in the policy store instance 655k associated with communication module 615k.

The coordinator module 625 is configured to assign network agents 605a-605n to communication modules 615a-615k. The coordinator 625 may use a sharding technique to balance load and improve efficiency of the network policy platform 610. The technique may use a number of buckets that may be used to partition the network agents and assign the network agents to communication modules (e.g., EFE modules). As will be described in further detail below, the buckets may also be used to distribute load if a communication module fails. The buckets may be thought of as groupings or partitions of network agents and may be numbered. For example, if there are i number of buckets, the buckets may be numbered continuously from 1 to i.

In various embodiments, each network agent may be assigned to a communication module by the coordinator based on a hash value associated with the network agent. For example, an agent identifier for the network agent may be put through a hash function (e.g., a Jenkins hash functions) in order to obtain a hash value for the network agent. The agent identifier may be, for example, a value that is based on a host name for the network agent, an IP address, a MAC address, or a combination of these values. The agent identifier may also be based on an operating system or BIOS for the network agent.

The coordinator may perform a modulo operation on the hash value for the network agent based on the number of buckets. For example, if there are 1024 buckets (i=1024), the operation would be the hash value mod 1024. The coordinator may use the result of the mod operation to assign the network agent to the corresponding bucket. For example, if the result of the mod operation was 122, the network agent would be assigned to bucket 122.

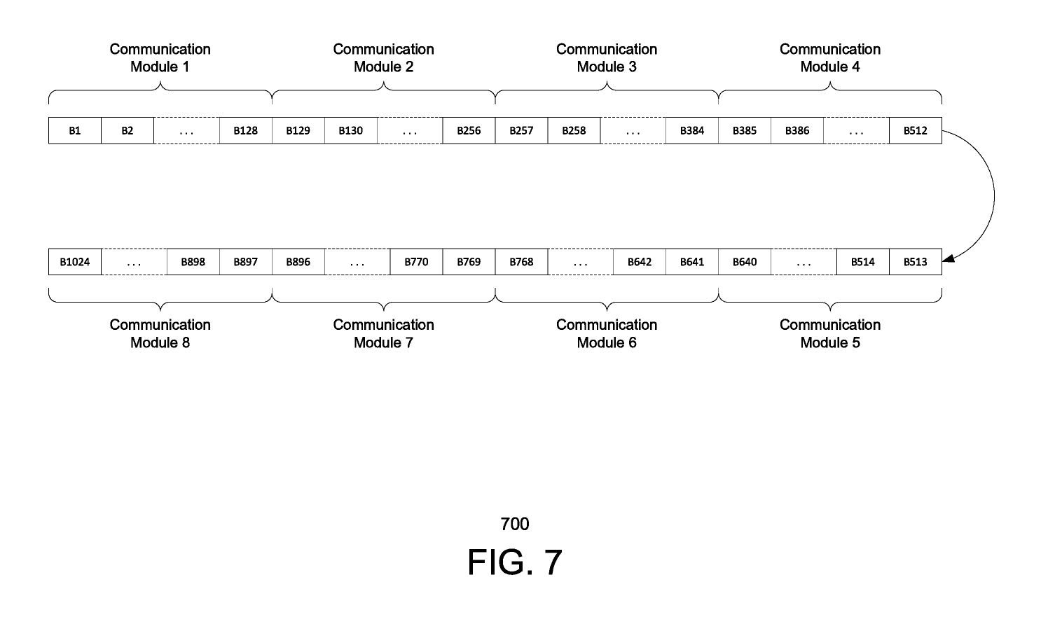

The coordinator may also assign buckets to communication modules. FIG. 7 is a conceptual bock diagram illustrating an assignment of buckets to communication modules, in accordance with various embodiments of the subject technology. In the example illustrated in FIG. 7, there are 8 communication modules in the network policy system and 1024 buckets. Buckets 1-128 may be assigned to one communication module, buckets 129-256 may be assigned to a second communication module, buckets 257-384 may be assigned to a third communication module, and so on until the last buckets 897-1024 are assigned to a last communication module.

The burden of communicating to all of the network agents (e.g., network agents 605a-605n) is thus distributed across a number of communication modules (e.g., communication modules 615a-615k). For example, a network agent may first make contact with the network policy system via any communication module and go through the registration process. During the registration process, the network agent will be assigned to a bucket that is assigned to a particular communication module. During subsequent communications with the network policy system, the network agent will know to contact the communication module that it is assigned to.

The network policies are also distributed across a number of policy store instances (e.g., policy stores 655a-655k) so that any single policy store does not need to store all network policies for all of the network agents. For example, when a new user intent statement is received and translated into network policies, the intent service 630 may identify which network agent the each network policy will operate upon, determine which communication module that the network agent is assigned to based on the hash function and modulo operations of the agent identifier, and store the network policy in the policy store instance associated with that communication module. For example, if the network policy to be stored is to operate on agent 605n in FIG. 6, the intent service 630 may determine that the agent 605n is assigned to communication module 615b and store the network policy in the policy store 655b that is associated with communication module 615b.

In some cases, communication modules may fail or otherwise become unreachable. Various aspects of the subject technology are directed to recovering from communication module failures such that the network policy system has a high degree of availability. If one communication module fails, the coordinator may reassign the buckets that previously were assigned to the failed communication module to the other operational communication modules. These buckets may be assigned evenly to the other operational communication modules in a round-robin fashion or other distribution scheme.

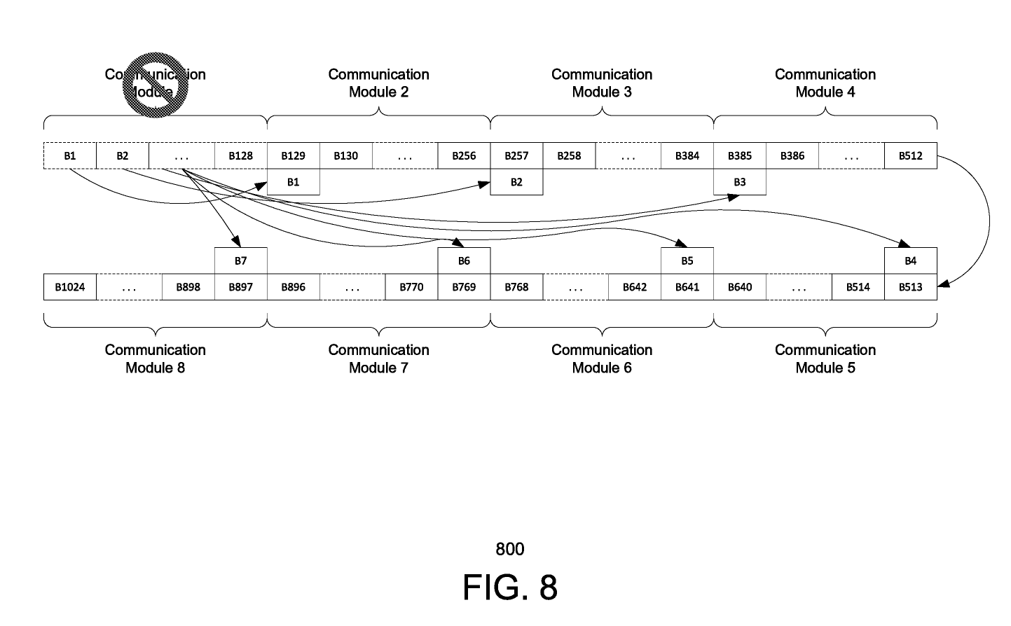

FIG. 8 is a conceptual bock diagram illustrating a failure of a communication module, in accordance with various embodiments of the subject technology. In FIG. 8, communication module 1 failed. The failure may be detected by the coordinator, which may send periodic “heartbeat” communications to the communication modules to check on the status of the communication modules. If a communication module does not respond within a predetermined time period (which may be measured by a timer), the communication module may be considered to have failed. The failure may be reported to the coordinator by the intent service when attempting to store network policies in the policy store instance associated with the failed communication module or reported by an agent assigned to the failed communication module that was unable to reach the failed communication module and, as a result, contacted another operating communication module.

As illustrated in FIG. 8, the buckets previously assigned to failed communication module 1 are reassigned by the coordinator to the other operational communication modules evenly. The coordinator may keep a log of bucket assignments and reassignments in order to keep track of which buckets are assigned to which communication modules.

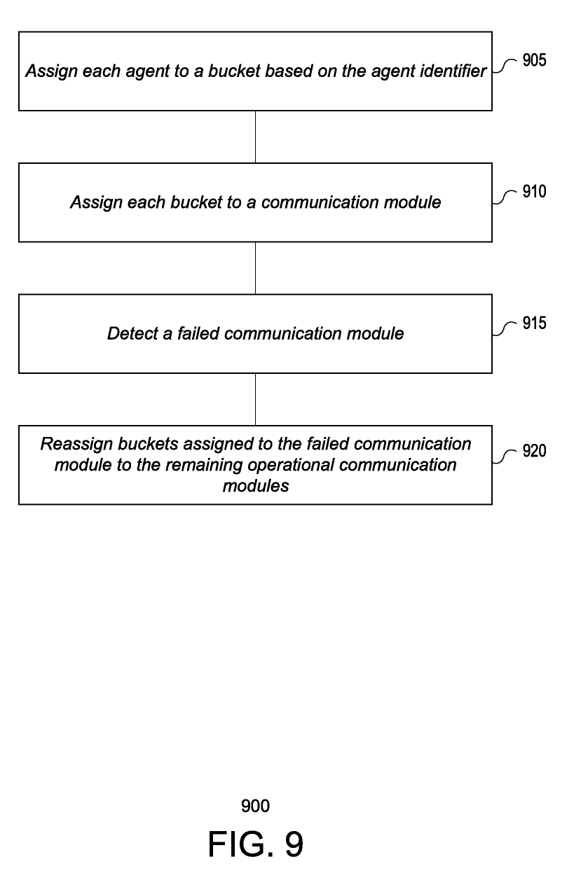

FIG. 9 shows an example process for reassigning network agents to communication modules, in accordance with various embodiments of the subject technology. It should be understood that, for any process discussed herein, there can be additional, fewer, or alternative steps performed in similar or alternative orders, or in parallel, within the scope of the various embodiments unless otherwise stated. The process 900 can be performed by a coordinator of the network policy system or similar system.

At operation 905, the coordinator assigns each network agent to a bucket based on the agent identifier. The coordinator may assign a batch of network agents at a time or one by one. For example, during registration, the coordinator may generate a hash value for a network agent based on the agent identifier of the network agent and mod the hash value to determine which bucket the network agent will be assigned to. At operation 910, the coordinator assigns each bucket to a communication module. The buckets may be assigned evenly to the existing communication modules and a record of the bucket assignments may be kept in a log.

At operation 915, the coordinator detects a failed communication module. The failure may be a result of a hardware or software problem with the communication module or as a result of the communication module becoming unreachable by the network policy system or by the network agents. The failure may be detected by the coordinator, which may send periodic communications to the communication modules, or reported to the coordinator. The intent service may report a failure to the coordinator if the intent service is unable to communicate with the communication module properly. An agent may report a failure to the coordinator if the agent is unable to reach the communication module it is assigned to. At operation 920, the coordinator reassigns buckets assigned to the failed communication module to the remaining operational communication modules.

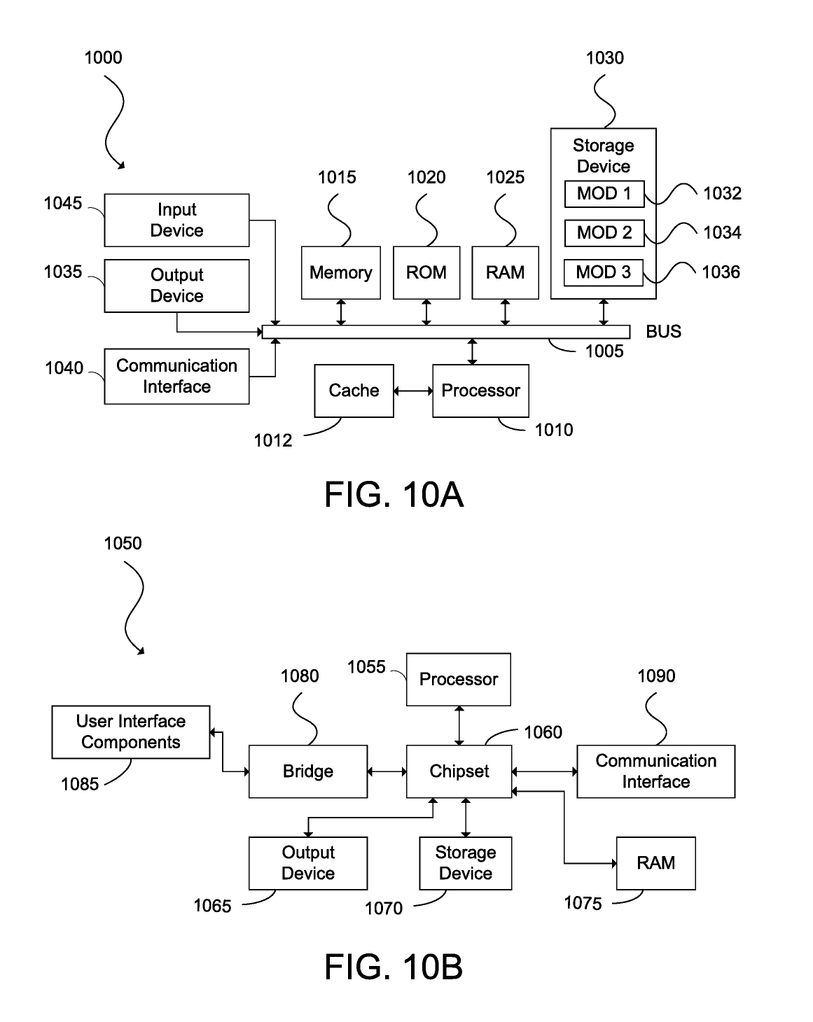

FIG. 10A and FIG. 10B illustrate systems in accordance with various embodiments. The more appropriate system will be apparent to those of ordinary skill in the art when practicing the various embodiments. Persons of ordinary skill in the art will also readily appreciate that other systems are possible.

FIG. 10A illustrates an example architecture for a conventional bus computing system 1000 wherein the components of the system are in electrical communication with each other using a bus 1005. The computing system 1000 can include a processing unit (CPU or processor) 1010 and a system bus 1005 that may couple various system components including the system memory 1015, such as read only memory (ROM) in a storage device 1020 and random access memory (RAM) 1025, to the processor 1010. The computing system 1000 can include a cache 1012 of high-speed memory connected directly with, in close proximity to, or integrated as part of the processor 1010. The computing system 1000 can copy data from the memory 1015 and/or the storage device 1030 to the cache 1012 for quick access by the processor 1010. In this way, the cache 1012 can provide a performance boost that avoids processor delays while waiting for data. These and other modules can control or be configured to control the processor 1010 to perform various actions. Other system memory 1015 may be available for use as well. The memory 1015 can include multiple different types of memory with different performance characteristics. The processor 1010 can include any general purpose processor and a hardware module or software module, such as module 1 1032, module 2 1034, and module 3 1036 stored in storage device 1030, configured to control the processor 1010 as well as a special-purpose processor where software instructions are incorporated into the actual processor design. The processor 1010 may essentially be a completely self-contained computing system, containing multiple cores or processors, a bus, memory controller, cache, etc. A multi-core processor may be symmetric or asymmetric.

To enable user interaction with the computing system 1000, an input device 1045 can represent any number of input mechanisms, such as a microphone for speech, a touch-protected screen for gesture or graphical input, keyboard, mouse, motion input, speech and so forth. An output device 1035 can also be one or more of a number of output mechanisms known to those of skill in the art. In some instances, multimodal systems can enable a user to provide multiple types of input to communicate with the computing system 1000. The communications interface 1040 can govern and manage the user input and system output. There may be no restriction on operating on any particular hardware arrangement and therefore the basic features here may easily be substituted for improved hardware or firmware arrangements as they are developed.

Storage device 1030 can be a non-volatile memory and can be a hard disk or other types of computer readable media which can store data that are accessible by a computer, such as magnetic cassettes, flash memory cards, solid state memory devices, digital versatile disks, cartridges, random access memories (RAMs) 1025, read only memory (ROM) 1020, and hybrids thereof.

The storage device 1030 can include software modules 1032, 1034, 1036 for controlling the processor 1010. Other hardware or software modules are contemplated. The storage device 1030 can be connected to the system bus 1005. In one aspect, a hardware module that performs a particular function can include the software component stored in a computer-readable medium in connection with the necessary hardware components, such as the processor 1010, bus 1005, output device 1035, and so forth, to carry out the function.

FIG. 10B illustrates an example architecture for a conventional chipset computing system 1050 that can be used in accordance with an embodiment. The computing system 1050 can include a processor 1055, representative of any number of physically and/or logically distinct resources capable of executing software, firmware, and hardware configured to perform identified computations. The processor 1055 can communicate with a chipset 1060 that can control input to and output from the processor 1055. In this example, the chipset 1060 can output information to an output device 1065, such as a display, and can read and write information to storage device 1070, which can include magnetic media, and solid state media, for example. The chipset 1060 can also read data from and write data to RAM 1075. A bridge 1080 for interfacing with a variety of user interface components 1085 can be provided for interfacing with the chipset 1060. The user interface components 1085 can include a keyboard, a microphone, touch detection and processing circuitry, a pointing device, such as a mouse, and so on. Inputs to the computing system 1050 can come from any of a variety of sources, machine generated and/or human generated.

The chipset 1060 can also interface with one or more communication interfaces 1090 that can have different physical interfaces. The communication interfaces 1090 can include interfaces for wired and wireless LANs, for broadband wireless networks, as well as personal area networks. Some applications of the methods for generating, displaying, and using the GUI disclosed herein can include receiving ordered datasets over the physical interface or be generated by the machine itself by processor 1055 analyzing data stored in the storage device 1070 or the RAM 1075. Further, the computing system 1000 can receive inputs from a user via the user interface components 1085 and execute appropriate functions, such as browsing functions by interpreting these inputs using the processor 1055.

It will be appreciated that computing systems 1000 and 1050 can have more than one processor 1010 and 1055, respectively, or be part of a group or cluster of computing devices networked together to provide greater processing capability.

For clarity of explanation, in some instances the various embodiments may be presented as including individual functional blocks including functional blocks comprising devices, device components, steps or routines in a method embodied in software, or combinations of hardware and software.

In some embodiments the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer readable media. Such instructions can comprise, for example, instructions and data which cause or otherwise configure a general purpose computer, special purpose computer, or special purpose processing device to perform a certain function or group of functions. Portions of computer resources used can be accessible over a network. The computer executable instructions may be, for example, binaries, intermediate format instructions such as assembly language, firmware, or source code. Examples of computer-readable media that may be used to store instructions, information used, and/or information created during methods according to described examples include magnetic or optical disks, flash memory, USB devices provided with non-volatile memory, networked storage devices, and so on.

Devices implementing methods according to these disclosures can comprise hardware, firmware and/or software, and can take any of a variety of form factors. Typical examples of such form factors include laptops, smart phones, small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

Although a variety of examples and other information was used to explain aspects within the scope of the appended claims, no limitation of the claims should be implied based on particular features or arrangements in such examples, as one of ordinary skill would be able to use these examples to derive a wide variety of implementations. Further and although some subject matter may have been described in language specific to examples of structural features and/or method steps, it is to be understood that the subject matter defined in the appended claims is not necessarily limited to these described features or acts. For example, such functionality can be distributed differently or performed in components other than those identified herein. Rather, the described features and steps are disclosed as examples of components of systems and methods within the scope of the appended claims.

1. A system comprising:
a processor; and
a non-transitory computer-readable medium storing instructions that, when executed by the system, cause the system to perform operations including:
assigning each agent of a plurality of agents to one bucket of a plurality of buckets based on an agent identifier of each agent;
assigning each bucket of the plurality of buckets to one communication module of a plurality of communication modules;
detecting a failed communication module in the plurality of communication modules; and
reassigning buckets assigned to the failed communication module to operational communication modules in the plurality of communication modules.

2. The system of claim 1, wherein the operations further include generating a hash value of the agent identifier of the agent, wherein the assigning of each agent to the one bucket is based on a result of a modulo operation on the hash value of the agent identifier.

3. The system of claim 1, wherein the detecting of the failed communication module comprises:
transmitting a status check to the failed communication module; and
determining that a timer expires before receiving an expected response to the status check.

4. The system of claim 1, wherein the detecting of the failed communication module comprises failing to store network policies in a policy store instance associated with the failed communication module.

5. The system of claim 1, wherein the detecting of the failed communication module comprises receiving a report of the failed communication module from a network agent assigned to the failed communication module.

6. The system of claim 1, wherein the operations further include:
storing a record of an assignment of each bucket of the plurality of buckets to the one communication module in a log of assignments; and
updating the log of assignments in response to the reassigning of the buckets assigned to the failed communication module to the operational communication modules.

7. The system of claim 1, wherein the operations further include receiving, from a network agent running on a network entity, a report comprising at least one of policy enforcement data associated with implementation of network policies on the network entity or system performance data associated with operation of the network entity.

8. The system of claim 1, wherein each communication module of the plurality of communication modules is associated with a policy store instance configured to store network policies associated with network agents assigned to the communication module.

9. The system of claim 8, wherein the operations further include:
receiving a user intent statement,
generating a new network policy based on the user intent statement;
identifying a network agent that will enforce the new network policy;
identifying a communication module assigned to the network agent; and
storing the new network policy in a policy store instance associated with the communication module.

10. The system of claim 9, wherein the identifying of the communication module assigned to the network agent is based on a hash of an agent identifier for the network agent.

11. A computer-implemented method comprising:
receiving a registration request from an agent;
identifying an agent identifier for the agent;
assigning the agent to a bucket of a plurality of buckets based on the agent identifier, wherein the bucket is assigned to one communication module of a plurality of communication modules;
determining that the one communication module has failed; and
reassigning the bucket to which the agent is assigned to an operational communication module in the plurality of communication modules.

12. The computer-implemented method of claim 11, further comprising generating a hash value of the agent identifier, wherein the assigning of the agent to the bucket is based on a result of a modulo operation on the hash value of the agent identifier.

13. The computer-implemented method of claim 11, further comprising:
storing a record of an assignment of the bucket to the one communication module in a log of assignments; and
updating the record in the log of assignments in response to the reassigning of the bucket to the operational communication module.

14. The computer-implemented method of claim 11, wherein the one communication module is associated with a policy store instance configured to store network policies associated with agents assigned to the one communication module.

15. The computer-implemented method of claim 11, further comprising:
receiving a user intent statement,
generating a new network policy based on the user intent statement;
identifying that the agent will enforce the new network policy;
determining that the agent is associated the one communication module; and
storing the new network policy in a policy store instance associated with the one communication module.

16. A non-transitory computer-readable medium comprising instructions, the instructions, when executed by a computing system, cause the computing system to perform operations comprising:
receiving a registration request from an agent;
identifying an agent identifier for the agent;
assigning the agent to a group of a plurality of groups based on the agent identifier, wherein the group is assigned to one communication module of a plurality of communication modules;
determining that the one communication module has failed; and
reassigning the group to which the agent is assigned to an operational communication module in the plurality of communication modules.

17. The non-transitory computer-readable medium of claim 16, wherein the operations further comprise generating a hash value of the agent identifier, wherein the assigning of the agent to the group is based on a result of a modulo operation on the hash value of the agent identifier.

18. The non-transitory computer-readable medium of claim 16, wherein the operations further comprise:
storing a record of an assignment of the group to the one communication module in a log of assignments; and
updating the record in the log of assignments in response to the reassigning of the group to the operational communication module.

19. The non-transitory computer-readable medium of claim 16, wherein the one communication module is associated with a policy store instance configured to store network policies associated with agents assigned to the one communication module.

20. The non-transitory computer-readable medium of claim 16, wherein the operations further comprise:
receiving a user intent statement,
generating a new network policy based on the user intent statement;
identifying that the agent will enforce the new network policy;
determining that the agent is associated the operational communication module; and
storing the new network policy in a policy store instance associated with the operational communication module.
